(19) United States
(12) Patent Application Publication
(10) Pub. No.: US 2025/0117432 A1
(43) Pub. Date: Apr. 10, 2025

(54) SYSTEMS AND METHODS FOR DATABASE MANAGEMENT INTEGRATING AI WORKFLOWS

(71) Applicant: TDAA Technologies Corp, Colorado Springs, CO (US)

(72) Inventors: Andrew McKennie Curran, Greenfield, MA (US); Jon Eric Farr, Colorado Springs, CO (US); Sandy Robert Friedman, Rancho Santa Margarita, CA (US)

(21) Appl. No.: 18/907,320

(22) Filed: Oct. 4, 2024

Related U.S. Application Data
(60) Provisional application No. 63/623,462, filed on Jan. 22, 2024.
(60) Provisional application No. 63/623,479, filed on Jan. 22, 2024.
(60) Provisional application No. 63/588,444, filed on Oct. 6, 2023.
(60) Provisional application No. 63/588,451, filed on Oct. 6, 2023.
(60) Provisional application No. 63/588,421, filed on Oct. 6, 2023.

(51) Int. Cl. G06F 16/903; G06F 9/451; G06F 16/9032

(52) U.S. Cl. CPC G06F 16/90335; G06F 9/453; G06F 16/9032

(57) ABSTRACT

Provided are systems and methods for AI management configured to guide interactions between end users systems and generative AI services. Various examples can manage data operations, among other options. In various embodiments, an AI management system is configured to host an interactive session via generating workflow steps for controlling interaction with AI models. The interactive session is configured to identify data management operations on user specified data sources. The AI management system can be used to analyze the data sources specified to generate a canonical data format spanning the multiple data sources, generate code for mapping the data sources into a canonical format, normalize the resulting data, cleanse the resulting data, validate the resulting data, and automatically generate code for each such function that can then be triggered by users interacting with the user interface.

### RELATED APPLICATIONS

This application claims priority under 35 USC 119 (e) as a Non-Provisional of Provisional U.S. Application Ser. No. 63/588,444, filed Oct. 6, 2023, entitled “SYSTEMS AND METHODS FOR REDUCING HALLUCINATION IN GENERATIVE AI AND LARGE LANGUAGE MODELS”. This application claims priority under 35 USC 119 (e) as a Non-Provisional of Provisional U.S. Application Ser. No. 63/588,451, filed Oct. 6, 2023, entitled “SYSTEMS AND METHODS FOR REDUCING HALLUCINATION IN GENERATIVE AI AND LARGE LANGUAGE MODELS”. This application claims priority under 35 USC 119 (e) as a Non-Provisional of Provisional U.S. Application Ser. No. 63/588,421, filed Oct. 6, 2023, entitled “SYSTEMS AND METHODS FOR DATA MANAGEMENT USING AI WORKFLOWS”. This application claims priority under 35 USC 119 (e) as a Non-Provisional of Provisional U.S. Application Ser. No. 63/623,462, filed Jan. 22, 2024, entitled “SYSTEMS AND METHODS FOR INTERACTION GOVERNANCE WITH ARTIFICIAL INTELLIGENCE”. This application claims priority under 35 USC 119 (e) as a Non-Provisional of Provisional U.S. Application Ser. No. 63/623,479, filed Jan. 22, 2024, entitled “SYSTEMS AND METHODS FOR INTERACTION GOVERNANCE WITH ARTIFICIAL INTELLIGENCE”. Each of which applications are hereby incorporated by reference in their entirety.

### BACKGROUND

Artificial intelligence and more specifically generative artificial intelligence (“GAI”) has become more prevalent, efficient, and accurate. For example, GAI is being used for building conversational outputs based on predicting what words or groups of words should be output in response to user inputs. Large language models (“LLM”) are now available that provide conversational outputs in response to natural language inputs via a prompt interface. The well-known CHATGPT is one example. There are known problems with the outputs generated from such systems. For example, the model can only function based on training data. A response cannot encompass information the model does not have accurately. Further, the outputs may not be accurate and may even be fabricated (“hallucinated”) while having the appearance of accuracy.

### SUMMARY

The inventors have realized that characterizing only wrong predictions as hallucinations has obscured the fact that all the outputs generated by AI models are all predictions that may only happen to be correct. The AI model itself has no intrinsic understanding of “correct” or “incorrect.” The focus on hallucinations has led to over investment in model development, model training, and even prompt engineering as single solutions to the hallucination problem. The inventors have realized that a model-agnostic, interaction-design-oriented approach provides the implementation required to improve over conventional solutions and provides a path for solving the hallucination problem. Various aspects of this approach utilize the interaction design as a focal point that can also leverage model refinement and/or prompt engineering to provide a holistic solution that improves AI model output accuracy and reduces error in prediction for any model and for any context.

For example, the inventors have realized generating step wise interactions with language models (e.g., LLM, SLM, etc.) and any GAI model provides opportunities to improve the accuracy of any responses produced, including, for example, conversational responses. Further, user interfaces can be tailored to display original data management, user queries, and/or user requests as a series of workflow steps, based on specially configuring an AI model to define output generation as a series of steps for a respective task, request, and/or query. According to one embodiment, the system is configured to optimize a final output/result based on a step-by-step workflow generated by AI models. For example, each step of the workflow can be used as an input to a model (e.g., an LLM, SLM, etc.), and can also include prompt based optimizations at each workflow step, improving their accuracy over conventional implementation. The workflow's step-by-step optimization can also be used to train or optimize existing AI models, including for example, LLM models, improving their accuracy over conventional approaches. Various embodiments implement a step-by-step AI output generation approach that reduces hallucination of conventional AI models, improving the underlying model, accuracy of outputs, and/or management of user interactions over known solutions.

According to one aspect, a system is provided. The system comprises at least one processor operatively connected to a memory, the at least one processor when executing configured to generate and display a guided session for data management interaction accept a user input specifying at least some of a request to be processed by a first AI model, generate a candidate workflow for executing a data management operation using the first AI model, the candidate workflow constrained to comprise a plurality of steps, process feedback on respective ones of the plurality of steps, and optimize generation of a final output for the data management operation based, at least in part, on execution of the candidate workflow by the first AI model, and any feedback on the respective ones of the plurality of steps.

According to one embodiment, the at least one processor is configured to trigger the first AI model to produce the candidate workflow to include at least one or more steps configured to produce anonymized data from at least one source data target. According to one embodiment, the at least one processor is configured to generate a unique identifier for linking anonymized information to an original record. According to one embodiment, the at least one processor is configured to optimize the one or more steps configured to produce anonymized data from the at least one source data target based on providing the feedback to the first AI model. According to one embodiment, the optimization includes functions to regenerate the one or more steps configured to produce anonymized or obscured data from the at least one source data target.

According to one embodiment, the first AI model is a large language model (“LLM”) trained to produce a natural language output in response to a natural language input. According to one embodiment, the at least one processor is configured to process groupings of the plurality of steps based on associated tasks. According to one embodiment, the at least one processor is configured to process groupings of the plurality of steps that include sub-steps associated with at least a respective one of the plurality of steps. According to one embodiment, the at least one processor is configured to enable selection of respective ones of the plurality of steps, and display a request for feedback on a selected one of the plurality of steps. According to one embodiment, the at least one processor is configured to regenerate the selected one of the plurality of steps based at least in part on the feedback using the first AI model or regenerate the candidate workflow based at least in part on the feedback using the first AI model.

According to one embodiment, the method further comprises a second AI model configured to generate executable code from any one or more of the plurality of steps. According to one embodiment, the second AI model is a large language model (“LLM”) trained to produce executable code in response to a text or natural language input. According to one embodiment, the first and second AI model are a same AI model.

According to one aspect, a computer implemented method is provided. The method comprises generating and displaying, by at least one processor, a guided session for data management interaction, accepting, by the at least one processor, a user input specifying at least some of a request to be processed by a first AI model, generating, by the at least one processor, a candidate workflow for executing a data management operation using the first AI model, the candidate workflow constrained to comprise a plurality of steps, processing, at least one processor, feedback on respective ones of the plurality of steps and optimize generation of a final output for the data management operation based, at least in part, on execution of the candidate workflow by the first AI model, and any feedback on the respective ones of the plurality of steps.

According to one embodiment, the method comprises triggering the first AI model to produce the candidate workflow and include at least one or more steps configured to produce anonymized data from at least one source data target. According to one embodiment, the method further comprises generating a unique identifier for linking anonymized information to an original record. According to one embodiment, the method further comprises optimizing the one or more steps configured to produce anonymized data from the at least one source data target based on providing the feedback to the first AI model. According to one embodiment, the optimization includes functions to regenerate the one or more steps configured to produce anonymized or obscured data from the at least one source data target. According to one embodiment, first AI model is a large language model (“LLM”) trained to produce a natural language output in response to a natural language input. According to one embodiment, the method further comprises processing groupings of the plurality of steps based on associated tasks.

According to one embodiment, the method further comprises processing groupings of the plurality of steps that include sub-steps associated with at least a respective one of the plurality of steps. According to one embodiment, the method further comprises enabling selection of respective ones of the plurality of steps, and displaying a request for feedback on a selected one of the plurality of steps. According to one embodiment, method further comprises regenerating the selected one of the plurality of steps based at least in part on the feedback using the first AI model or regenerating the candidate workflow based at least in part on the feedback using the first AI model. According to one embodiment, the method further comprises a second AI model configured to generate executable code from any one or more of the plurality of steps. According to one embodiment, the second AI model is a large language model (“LLM”) trained to produce executable code in response to a text or natural language input. According to one embodiment, the first and second AI model are a same AI model.

According to one aspect, a system is provided. The system comprises at least one processor operatively connected to a memory, the at least one processor when executing configured to generate and display a guided session for managing interaction with a first AI model, accept a user input specifying a request to be processed by the first AI model, generate a candidate workflow using the first AI model for producing a final output to the user input, the candidate workflow comprising a plurality of steps, request user feedback on respective ones of the plurality of steps, optimize generation of the final output based, at least in part, on execution of the candidate workflow by the first AI model, and any user feedback on the respective ones of the plurality of steps.

According to one embodiment, the first AI model is a large language model (“LLM”) trained to produce a natural language output in response to a natural language input. According to one embodiment, the at least one processor is configured to display groupings of the plurality of steps based on associated tasks. According to one embodiment, the at least one processor is configured to display groupings of the plurality of steps that include sub-steps associated with at least a respective one of the plurality of steps. According to one embodiment, the at least one processor is configured to enable selection of respective ones of the plurality of steps, and display a request for feedback on a selected one of the plurality of steps. According to one embodiment, the at least one processor is configured to regenerate the selected one of the plurality of steps based at least in part on the feedback using the first AI model or regenerate the candidate workflow based at least in part on the feedback using the first AI model. According to one embodiment, the at least one processor is configured to trigger the first AI model construct a set of candidate workflow steps in response to the user input specifying the request to be processed.

According to one embodiment, the at least one processor is configured to constrain the output generated by the first AI model of the set of candidate workflow steps to include a minimum threshold of steps. According to one embodiment, the first AI model is further trained on a minimum number of steps that improve the output produced during generation of the candidate workflow steps. According to one embodiment, the first AI model is trained on supervised learning instances of improved workflow and final output generation. According to one embodiment, the first AI model is trained or tuned based on executing the user input specifying the request to be processed without augmentation and comparison to outputs produced based on executing the candidate workflow. According to one embodiment, the comparison evaluates respective outputs on at least one of hallucinated output, accuracy, or alignment with user goals.

According to one aspect, a computer implemented method for improving AI execution is provided. The method comprises generating and displaying, by at least one processor, a guided session for managing interaction with a first AI model, accepting, by the at least one processor, a user input specifying a request to be processed by the first AI model, generating, by the at least one processor, a candidate workflow using the first AI model for producing a final output to the user input, the candidate workflow comprising a plurality of steps, requesting, by the at least one processor, user feedback on respective ones of the plurality of steps, optimizing, by the at least one processor, generation of the final output based, at least in part, on execution of the candidate workflow by the first AI model, and any user feedback on the respective ones of the plurality of steps.

According to one embodiment, the first AI model is a large language model (“LLM”) trained to produce a natural language output in response to a natural language input. According to one embodiment, the method comprises display groupings of the plurality of steps based on associated tasks. According to one embodiment, the method comprises displaying groupings of the plurality of steps that include sub-steps associated with at least a respective one of the plurality of steps. According to one embodiment, the method comprises enabling election of respective ones of the plurality of steps, and displaying a request for feedback on a selected one of the plurality of steps. According to one embodiment, the method comprises regenerating the selected one of the plurality of steps based at least in part on the feedback using the first AI model or regenerating the candidate workflow based at least in part on the feedback using the first AI model. According to one embodiment, the method comprises triggering the first AI model construct a set of candidate workflow steps in response to the user input specifying the request to be processed.

According to one embodiment, the method comprises constraining the output generated by the first AI model of the set of candidate workflow steps to include a minimum threshold of steps. According to one embodiment, the method comprises training the first AI model on a minimum number of steps that improve the output produced during generation of the candidate workflow steps. According to one embodiment, the method comprises training the first AI model on supervised learning instances of improved workflow and final output generation. According to one embodiment, the method comprises training or tuning the first AI model based on executing the user input specifying the request to be processed without augmentation and comparison to outputs produced based on executing the candidate workflow. According to one embodiment, the executing the comparison includes evaluation of respective outputs on at least one of hallucinated output, accuracy, or alignment with user goals.

According to one aspect, an AI workflow system is provided. The system comprises at least one processor operatively connected to a memory, the at least one processor when executing configured to process a user input including a request, using at least a first AI model, instantiate the at least first AI model, the at least first AI model trained to produce a natural language output in response to a natural language input, constrain the natural language output produced by the at least first AI model based on requirements for generating an AI workflow, wherein constraining the natural language output includes causing the at least one processor to request the at least first AI model define at least one step to be used by the at least first AI model in developing a final output responsive to the user input, and execute the AI workflow using the at least first AI model to produce the final output. According to one embodiment, the at least first AI model includes a language based model (“LLM” or “SLM”).

According to one embodiment, the at least one processor is configured to incorporate the AI workflow generation requirements into an input provided to the at least first AI model. According to one embodiment, the at least one processor is configured to incorporate the AI workflow generation requirements and the user input into the input provided to the at least first AI model. According to one embodiment, the at least one processor is configured to fine-tune the first AI model responsive to user feedback. According to one embodiment, the at least one processor is configured to define prompt inputs responsive to user feedback. According to one embodiment, the at least one processor is configured to incorporate the prompt inputs into the request to the first AI model to define the at least one step. According to one embodiment, the at least one processor is configured to define prompt inputs responsive to user feedback, and execute the AI workflow with the prompt inputs as input to the first AI model to produce the final output.

According to one aspect, a method for generating an AI workflow is provided. The method comprises processing, by at least one processor, a user input including a request, using at least a first AI model, instantiating, by the at least one processor, the at least first AI model, the at least first AI model trained to produce a natural language output in response to a natural language input, constrain the natural language output produced by the at least first AI model based on requirements for generating an AI workflow, wherein constraining the natural language output includes causing the at least one processor to request the at least first AI model define at least one step to be used by the at least first AI model in developing a final output responsive to the user input, and execute the AI workflow using the at least first AI model to produce the final output. According to one embodiment, the at least first AI model includes a language based model (“LLM” or “SLM”).

According to one embodiment, the method comprises incorporating the AI workflow generation requirements into an input provided to the at least first AI model. According to one embodiment, the method comprises incorporating the AI workflow generation requirements and the user input into the input provided to the at least first AI model. According to one embodiment, the method comprises fine-tuning the at least first AI model responsive to user feedback. According to one embodiment, the method comprises defining prompt inputs responsive to user feedback. According to one embodiment, the method comprises incorporating the prompt inputs into the request to the first AI model to define the at least one step. According to one embodiment, the method comprises defining prompt inputs responsive to user feedback, and executing the AI workflow with the prompt inputs as input to the at least first AI model to produce the final output.

Other advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by references signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 is a block diagram of an example implementation, according to one embodiment;

FIG. 2 is an example process flow, according to one embodiment;

FIG. 3 is an example user interface, according to one embodiment;

FIG. 4 is an example user interface, according to one embodiment;

FIG. 5 is an example user interface, according to one embodiment;

FIG. 6 is an example of process flow, according to one embodiment;

FIG. 7. is an example user interface, according to one embodiment;

FIG. 8 is a block diagram of an example computer system improved by implementation of the functions, operations, and/or architectures described herein;

FIG. 9 is an example block diagram and functionality flow of an implementation environment, according to one embodiment;

FIG. 10 illustrates example logic blocks that can be implemented in various embodiments; and

FIG. 11 is an example block diagram and functionality flow of an implementation environment, according to one embodiment.

### DETAILED DESCRIPTION

According to various embodiments, an AI data management and workflow system is configured to manage interactions between end users (and, for example, their associated systems) and generative AI services that manage data transformation, data normalization, data obfuscation, data validation/cleansing, and/or data anonymization, among other options. In various embodiments, the AI management system is configured to host an interactive session for any end user or system that provides data management tools via generating workflow steps for the underlying data. The interactive session is configured to identify data management operations on user specific data sources. In various examples, a user (e.g., administrator, database administrator, etc.). can designate a variety of data sources (e.g., heterogeneous, homogeneous, relational, non-relational, etc.) via a user interface. The AI management system can be used to analyze the data sources specified to generate a canonical data format spanning the multiple data sources, generate code for mapping the data sources into a canonical format, normalize the resulting data, cleanse the resulting data, validate the resulting data, and automatically generate code for each such function (e.g., obfuscate, anonymize, transform, merge, de-duplicate, normalize, cleanse, and/or validate the data) that can then be triggered by users interacting with the user interface.

According to one embodiment, the system leverages a plurality of language models (e.g., LLMs, SLMs, etc.) to request that the models analyze data sources to identify a set of workflow steps to produce a canonical data schema, rather than generate an output that specifies the canonical data schema format, as would be done in conventional implementation. Generally, a user can specific a request to produce an output by the system that is process by an AI model. Rather than output the result of such a request, the system is specially configured to have the AI model break down the generation of the requested output into a series of steps, and provide optimization at each such step. In the canonical formatting example, once a final canonical format is approved, the anonymization, obfuscation, merging, deduplication, transformation, normalization, cleansing, and validation functions can be decomposed into a series of workflow steps that the models identify, present, and optimize (optionally based on feedback in an interactive session). Optimization may include, user provided feedback, fine-tuning AI models, and/or prompt engineering of requests to the AI models, for example, with respect to each step and the model as well.

According to various embodiments, the optimized workflows can then be executed to produce more accurate (e.g., less hallucinations) and refined results (e.g., improved precision) over conventional approaches. In further embodiments, an AI management system is provided that is configured to break data management tasks into workflows that can be presented in user interfaces, critiqued and/or accepted, and once validated used to automatically generate code in a variety of different programming languages or third party data integration applications and platforms for each function.

In various examples, the workflow breakdown of steps includes a rationale and/or specific step-by-step process for data management functions, generating a response to a user request and/or query, among other options. According to some embodiments, each articulation of the rationale and/or process steps can be leveraged by the system to improve the ultimate output (e.g., data management task, user request, and/or query response). Each step and/or rationale can be used to optimize the generation of the final AI output, and may be implemented in a guided session/display, for example, as part of an interactive session with a user. In various embodiments, the interactive session provides an assistant functionality to respective users, and further each assistant based service or session can be tailored to specific contexts in which assistance is required. For example, underlying AI models can be specifically tailored to a user context. In another example, prompt inputs used to constrain or optimize AI model outputs can be tailored to specific contexts. Some embodiments include combinations of tailored models and tailored prompts.

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

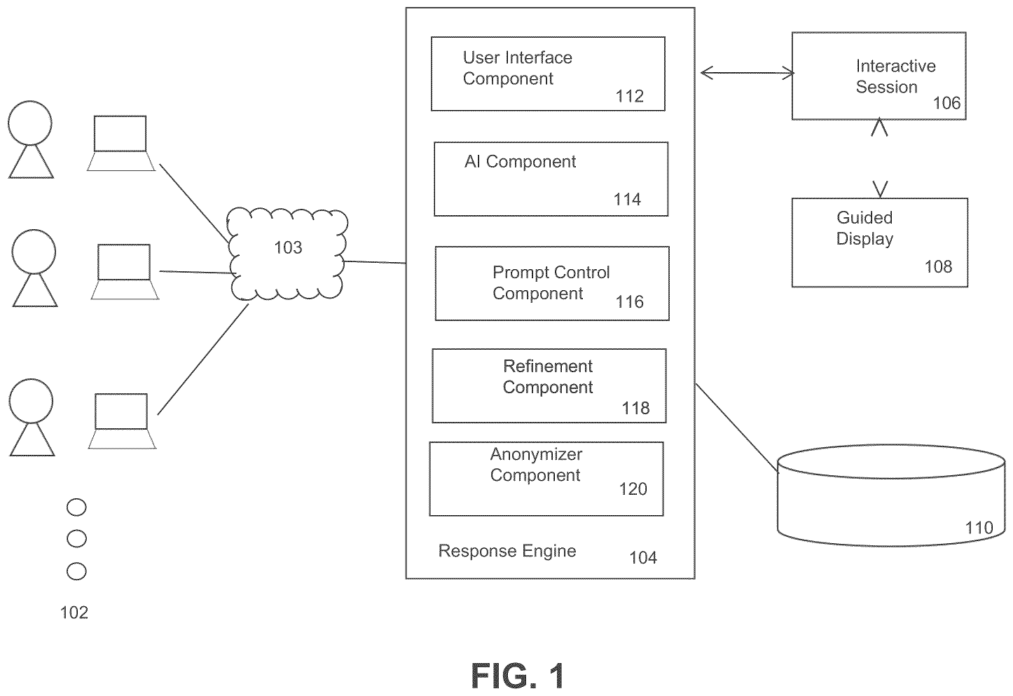

FIG. 1 is a block diagram of an example AI data management and workflow system 100. According to one embodiment, the workflow system 100 can be configured to manage user interaction with AI models to produce improved outputs, and, for example, AI outputs having fewer hallucinations than known approaches. According to one embodiment, the system 100 and/or response engine 104 can be configured to instantiate a plurality of components configured to perform or execute the functions described below. In other embodiments the system 100 and/or response engine 104 can be configured to perform the functions directly without requiring any specialized component.

Users (e.g., 102) can interact with the system via a network connection (e.g., 103). The network connection can be, for example, the Internet or other network (e.g., wide area network, local area network, connection to cloud computing resources, among other examples). According to one embodiment, a user (e.g., 102) can access the system via an Internet connection and interact with a user interface generated by user interface component 112. In some embodiments, the user interface component 112 is configured to guide the user through an interactive session (e.g., 106). As part of the interactive session 106, the user interface can present or display a text input or other query interface to the user. In one example, the user interface can include a display tailored to user identification of data sources. Once a user supplies an input, the system is configured to guide the user via the interactive session to ultimately produce an output responsive to the user's request.

According to various embodiments, the system is configured to provide an assistance function suite for data management operations, and may also include functionality to flatten or de-normalize data, anonymize sensitive data in a way that allows for the anonymized file to be associated with the sensitive data in a later process, and also generate code according to a data management workflow defined and/or optimized during an interactive session. In further examples, the system can be configured to obfuscate fields in addition to anonymization. In some examples, data can be mutated to obscure the underlying values. The mutations and/or transformation algorithms can be generated by a client, maintained by a client, enabling increased security even when the workflow system is operating to manage data. According to various embodiments, the system can enable users to identify fields to obscure, fields to anonymize, etc., in a user interface. The system is configured to manage the data transformations and/or mutations on the specified fields. In some alternatives, the system can crawl or analyze client data and identify candidate fields to anonymize and/or obfuscate. For example, via a locally executing process. Client preferences can be specified to enable the system to select between anonymize/obfuscate function, among other options. In one example, the system can generate an initial or candidate workflow for an operation, and refine the candidate workflow with user feedback.

According to one embodiment, the user can define any number of data sources in the user interface, for example, during the interactive session. The system is configured to analyze the identified data sources and may use a first high level goal of defining a recommended list of data fields to anonymize and/or defining or generating a canonical data format for the identified data sources. According to one embodiment, the AI component 114 is configured to analyze the data sources. According to some embodiments, the AI component 114 is configured to accept a user input and produce a responsive output based on providing the identified data sources and a task as a prompt to a trained AI model. In one example, the trained model is a language model (e.g., an LLM). Conventionally, an LLM is configured to accept a user input specifying data sources and a request to build a data model, and the LLM is configured to produce a responsive output specifying the data model.

In various embodiments, the system, response engine, or AI component can be configured to generate a workflow for constructing a common data model based on the identified data sources. The AI generated workflow can include a plurality of steps, including for example, extract data fields, identify common data fields, identify similar data fields, map similar data fields, process user identified data mappings, link specified terms, link data fields, etc. Each step can be presented as part of a guided session or display (e.g., 108). In various embodiments, once a set of steps has been confirmed, or optimized according to provided feedback, the AI component is configured to generate code to accomplish the set of steps.

Generally, an AI model (e.g., LLM) can be given a request to generate code having users specify functions and request code generation and return executable code as an output. In various embodiments, this capability is improved by having the workflow decompose coding or overarching tasks into a series of steps/tasks and generating code associated with each step. Additionally, the code from respective prior steps can be used as part of a prompt input for generating code for a next step, improving the ability of the model to generate precise and accurate code. In other embodiments, the workflow can be used as the input to the model to generate code, and the specification of the workflow as steps improve over conventional implementation in terms of accuracy, precision, and reduced error in generated code, among other examples.

According to various embodiments, the system can be configured to provide prompt inputs to the language model (e.g., LLM) in conjunction with specification of one or more data sources. The prompt input can be tailored so that the LLM generates a workflow output for producing an abstract data schema rather than producing a discrete data schema directly, as would be done in conventional approaches. In one example, the system is configured to transform a request on the model so that the prompt input specifies that the LLM must construct or identify a series of steps that should be executed to produce the abstract data schema. The prompt input can be generated by the system or transformed from a user request to include constraints or requirements on a generated workflow. The constraints can specify a minimum number of steps, identify specific parameters that are required (e.g., in an output data model) which can be input by the user, and for example, in the context of data management operations, specify an order of precedence for the data and/or data model, among other options. Various constraints can be automatically supplied by the system and can optionally include, combine, and/or modify constraints specified by the user.

Generally stated, the trained model (e.g., LLM) can produce a workflow that identifies a series of tasks for any data management approach, including, for example: identify common data fields, identify similar data fields, optionally, consolidate similar data fields, and generate mappings from the data sources to the common data schema, transform data from one schema to another, normalize data, cleanse data, merge data, de-duplicate date, anonymize data, among other options. Each task may include additional steps or sub-steps. In some embodiments, the system is configured to allow a user to request any one or more of the above functions, generate a workflow in the background, execute the workflow and produce an output based on executed workflow (e.g., output abstract data schema, and/or code to generate the abstract data schema, etc.). In other embodiments, the system is configured to enable user interaction with at least one of the workflow steps, providing the option for user feedback to inform workflow generation, step re/generation, prompt engineering to include feedback, among other options.

In further embodiments, the guided display is also configured to show the user a series of steps and/or processes that define a workflow used to produce the ultimate output, and allow the system to interact with the user to optimize the workflow steps. For example, the user interface component 112 can be configured to accept a user request/input and provide that request/input to the AI component 114 with instruction to produce a series of steps and/or processes that would be used to provide an answer or output associated with the user request/input. According to some embodiments, an LLM can be given the user input with additional requirements (e.g., defined as a prompt input) to produce the series of steps and/or processes that would be used to generate a response. In various embodiments, the series of steps and/or processes can be used by the system to produce a more accurate final response relative to conventional approaches. For example, by executing each step of a workflow rather than producing an output directly many models (e.g., language models, GAI, etc.) produce more accurate results, including for example, results with fewer hallucinations. In other examples, the interactive session provides direct feedback on the various steps, including acknowledgement of a generated workflow step, refinement actions (e.g., do “x” and do not do “y”), and the feedback can be used to improve each workflow step, and yield additional improvements in accuracy and precisions for the output. In some examples, the steps and/or processes output by the model are used to build a guided display 108 shown to end users 102. In some embodiments, the system automatically produced positive and/or negative examples to refine one or more steps in a workflow. In others, user can supply, augment, and/or modify positive and/or negative constraints (e.g., that can be used/integrated with prompts in AI output generation, among other options).

In some embodiments, the system can include a prompt control component 116. The prompt control component 116 can be configured to add requirements to trigger a model (e.g., an LLM, SLM, GAI model, etc.) to produce the series of steps/processes that make up a workflow. In other examples, the prompt control component 116 can be configured to request that a GAI model produce a rationale associated with generating high level data management functions (e.g., create an abstract data schema, transform data from one schema to another, de-duplicated data, merge data, normalize data, cleanse data, validate data, anonymize data, obfuscate data, etc.). Stated generally, various GAI models can be used to produce a set of steps, processes, rationales, etc., that form the basis of a workflow optimization that improves final outputs delivered by any AI model.

According to one embodiment, each step produced can be displayed as part of an interactive session 106 and shown in a guided display 108. Each step may also include a request to a user to agree or disagree with the workflow steps generated and/or the content of each step. In still other examples, a user may be asked in the interactive session 106 to agree or disagree with respective steps and/or content and provide their reasoning for the agree disagree input. Some embodiments solicit critiques of the workflow steps more generally, and can request feedback on respective steps. The feedback can be used immediately to reproduce the workflow steps (e.g., using the feedback as part of the input to an AI model and the request to produce a rationale or set of steps), and shown in the guided display. In some examples, further feedback can be requested (including, for example, requests to indicate “Improved?” “Not improved?). Each feedback request can be used to improve underlying models via fine-tuning and/or can be used as part of or as prompt inputs to models to tailor respective outputs.

In another example, the guided display may ask a user more specifically: define a task that should be done for a given step (e.g., specify an action-based task) and/or define a task that should not be taken for a given step (e.g., specify an action that should not be taken). For example, the user can define data fields in their data sources that should remain pristine (unmerged), and/or identify known duplicates fields, matched data fields with different names, etc. The user may be asked for a reasoning as to why they indicated: do “this” and do not do “that.” In one example, the user interface presents these requests and presents open text boxes for responses. Each of the responses provided by the user can be used by the prompt control component to guide interactions with the AI component 114 and/or underlying model. As discussed above, the guided display can be updated immediately in response to feedback, and/or the feedback can be captured and used for fine-tuning models, and/or developing prompt inputs to include in requests made on the AI model.

In some embodiments, the system can include a refinement component 118. The refinement component can be configured to fine tune underlying models (e.g., an LLM). For example, the underlying model can be retrained based on the identified steps, processes, critiques, and/or rationale generated, and may be refined in conjunction or separately from the feedback provided for each step, process, or rationale in the associated workflow. According to various embodiments, the user inputs and outputs produced by associated models during an interactive session can be used by either the refinement component 118 or the prompt control component to improve the outputs generated by GAI models. In still other embodiments, the same or various combinations of the information can be used by both the refinement component 118 and prompt control component 116 to improve associated outputs. In some examples, the system can include a database 110 to store user input, workflow steps, interactive sessions, AI outputs, among other options. The associated data can be used as discussed above to improve engineered prompts to AI models, fine tune underlying models, among other options that yield more accurate outputs, and/or reduce hallucination and the outputs produced.

According to some embodiments, the system can be configured to manage prompt engineering inputs to an AI model that are tailored to force the AI model to produce outputs having defined characteristics or constraints. For example, when generating workflows associated with data management functions and/or user specified data sources, the system can be configured to define a minimum and/or maximum number of steps that should be produced, for example, on respective high-level targets (e.g., define common data format/schema, de-duplicate data, merge data, normalize data, transform data from one schema to another, anonymize data, obfuscate data, cleanse data, validate data, etc.) or based on an entire workflow, among other options. In other embodiments, the system can be configured to request a number of parameters for rationale or steps produced by the AI depending on context. For example, the system can define settings or context for user interaction (e.g., assistant mode, code generation mode, data management, data processing/analytic mode, etc.). Each setting or context can be associated with rationales, and a prompt input can be included to specify the rationale as part of any prompt or input given to an AI model, among other options.

According to various embodiments, the AI workflow system is configured to decompose a conventional approach for input to an AI model to produce a responsive output into a series of steps, produced by an AI model that it predicts would be used to produce a responsive output given a certain input. By decomposing the input/output generation process into a series of steps, the same AI model is now able to optimize the final output produced by executing through a series of steps that more effectively causes the AI to define the responsive final output. Further embodiments leverage the steps produced to include additional optimizations at each respective step. For example, feedback can be specified on the definition of each step. In another example, each step can be accompanied by prompts to include with the step when input into the AI model. The prompts can be based on information captured from prior execution, contextual rules, and/or based on feedback provided. Such prompt engineering enables the AI workflow system to produce output to requests with greater accuracy than known approaches.

According to further embodiments, the system 100 and/or engine 104 can include an anonymizer component 120. According to one embodiment, the anonymizer component 120 is configured to process any data input to construct an anonymized version of the input data. In one example, the anonymizer component 120 can be configured to work in conjunction with AI data analysis and automatic code generation functions described above to produce anonymized data as a common format is being generated.

In one example, personally identifiable information can be identified within a data source or a common data format constructed from a variety of sources. The identification of the personally identifiable information can be presented as a step in a workflow, and the user can provide feedback-agree this is personally identifiable information or disagree, with a request to provide information on why. The feedback then is leveraged to improve workflow step generation.

Code for mappings from source data to a common format version of the data can also be generated to include replacement of personally identifiable information with unique identifiers and/or obscured information. Depending on system settings (which can be set by a client) the common format version of the data can be anonymized by using a unique identifier in place of identifying information. In another example, personally identifiable information can be obscured or altered and the identity can be assigned a unique identifier. In some examples, a workflow step can be presented as to how the data will be obscured, and a feedback request on the operation can be shown in the user interface (e.g., agree, disagree, why, and may also include a request to improve or change the operation(s)). As discussed above, the anonymization workflow step can then be improved by incorporating the feedback into a regeneration of the respective step or task.

According to various embodiments, the client can retain the information linking any unique identifier to any obscured personally identifiable information. In various embodiments, the functionality and components shown in FIG. 1 can be distributed and can operate on systems controlled by clients. In various embodiments, the functionality to produce anonymized data can be executed entirely within the confines of a client system. Complete control over the underlying data and even anonymized data can be retained by the client/client systems. In other embodiments, and for example, based on system settings, both source and common format data can be converted into anonymized data, and clients or client systems can secure the linking information according to their own security preferences, and do so without exposing underlying data to any external systems.

According to one example, the system is configured to identify sensitive data fields. For example, and reference to social security number can be identified (e.g., soc #, social security no., SS #, etc.) and transformed into another value. The another value can be associated with a unique identifier that a client/client system can manage that links the unique identifier to the original information (e.g., via key and id linkage, among other options).

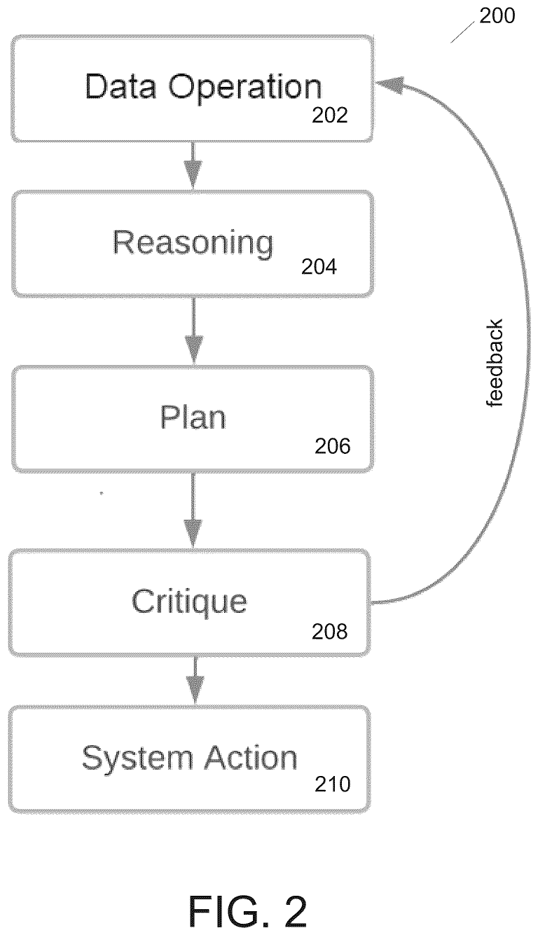

FIG. 2 is an example process flow 200, that illustrates at a high-level an example of instructing an AI model to articulate a set of workflow steps (e.g., reasoning and internal process) that are performed in response to an input, including a system controlled data management operation. In the context of a AI managed chat interface, the process 200 can be executed to identify workflow steps that begin with a user input (e.g., text, identification of data sources, data management request or operation, etc.), generation of a set of workflow steps that are associated with producing a response to the user input, optimization (e.g., critique) of the workflow steps, and generation of a final output for to the user input (e.g., system action). More generally, process 200 can begin at 202 with an idea indicated via input to a user interface. In an AI data management context, a user input can be provided via visual selection of data sources, text-based, voice input, among other options and can be used to define a data management request, or more generally an idea that will be the basis of AI generated data management operations.

For example, a request can be presented in a user interface to transform data sources from one schema to another, de-duplicate data, merge data, normalize data, obscured data, validate and/or cleanse data, and/or anonymize data. The request and/or input can be used to generate a workflow for responding using an AI model, and for example, an LLM. Returning to the process 200 once a user input has been received (e.g., 202), process 200 can continue at 204 with a request to define the reasoning or process steps associated with responding to the idea. In some embodiments, an AI model can be asked “to show its work” in response to an idea articulated by a user. The request to “show its work,” can include specification of structure for articulating a reasoning at 204. In one example, a reasoning request at 204 can include a requirement that the rationale or reasoning be broken down into a set having a minimum number of steps (e.g., at least three steps), and may also include a requirement to state a high-level step and specific sub-steps for any required number of steps, and can optionally include a requirement for a minimum number of sub-steps.

According to one embodiment, an AI model can be asked how many steps should be used for a given idea or input as part of the reasoning analysis of 204. Process 200 can use the AI determined number as a further prompt to the AI model when establishing requirements for defining steps of a workflow. In other examples, the system can invoke rule-based logic to define a set of steps and/or sub-steps that are requested as part of the output. In some examples, a context can be used by the system to retrieve pre-defined operations that can be used in conjunction with user inputs to AI models, for example, as part of prompt engineering for generating an AI output. In on example, the system can identify a data management context, and used pre-defined high level tasks (e.g., generate common data model, generate data model for source, identify similar fields for consolidations, data deduplication, generate transformations for data from one schema to another, normalization of data, cleansing of data, validation of data, among other options).

In further example, these requirements can be submitted to an AI model as part of a prompt to ensure specific conditions are met when building or defining a reasoning. Once the set of steps is defined, they can be presented as a plan at 206, assuming any input requirements are met. If input requirements have not been met, the prompt information can be updated and the set of steps regenerated. Prompt updates can be made by requesting the AI model provide a prompt update to resolve any deficiency, for example.

According to some embodiments, as part of defining the plan 206, the process 200 may validate if a produced plan meets any specified requirements. Optionally, the plan defined at 206 can be presented to an end user. Each step and/or sub-step may include a request to critique the stated action, step, and/or concept. Each critique can be used as part of a feedback loop for idea generation in 202, reasoning articulation at 204, and/or planning at 206. Shown in the example process flow is a feedback loop to step 202, however the feedback loop may be introduced at any preceding step to improve the definition of a plan.

Once any critique has been entered for any defined step or sub-step, process 200 can continue at 210 with system action. According to one embodiment, the system action at 210 includes executing the workflow defined to respond to user input/idea.

In other embodiments, the system action can include code generation that accomplishes the defined steps. For example, an LLM (e.g., ChatGPT) can be configured to produce code from natural language input and an identification of a code base to use for generating the source code. The system can supply the set of steps as functionality to be reduced to source code and supply a default code language to use. In other examples, users can identify a coding language to use as part of system preferences.

In the data management context, generating a common data schema can include mapping of data fields from one or more data sources to a destination database. An LLM can be used to build code for moving or transforming the source data to the destination database. For example, the mappings can be used as an input with a request to provide executable code to the LLM. The resulting code can be provided via download. In some embodiments, the interactive session can be configured to build a validation test for the generated code. For example, the user can trigger a test run of the code against the source data, and the destination database can be evaluated to determine validity. In some examples, the AI model can be asked to evaluate the destination database to ensure it matches the field and properties defined in respective workflow steps, among other options.

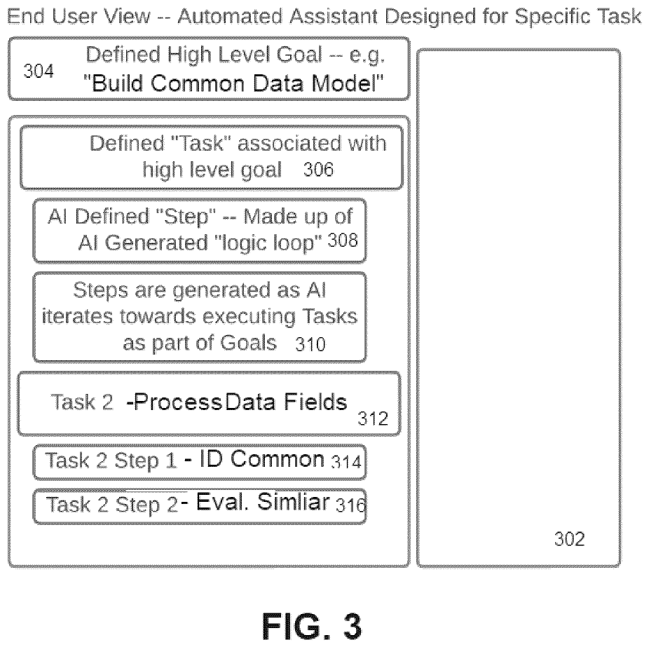

FIG. 3 shows an example user interface for managing a chat session with an end user. According to one embodiment, the interface 300 can be presented as an end user view of an automated assistant. The automated assistant can be designed for specific tasks and/or tailored to a specific context or setting. More generally, the interface 300 is configured to manage an interactive session with an end user to define high-level goals, tasks, and steps that are based on an AI generated logic loop.

Shown in FIG. 3 is a chat or interactive portion of the window that can be displayed to an end user (e.g., 302). The end user may enter information into the interactive portion of the window 302. In some embodiments, the user input is used to extract a high-level goal or accept a user definition of a high-level goal (e.g., marketing campaign 304). In one example, input at 302 is used to define a high-level goal associated with the user input as well as any tasks associated with a high-level goal (e.g., shown at 306). According to one embodiment, the input of 302 is used by an AI model which may be accompanied by requirements identified in the input to the AI model to produce a high-level goal and one or more tasks associated with the high-level goal as an output. According to another embodiment, the user interface can include prompts requesting that the user identify a high-level goal associated with their input or desire, as well as at least one task associated with the high-level goal.

Although some embodiments provide access to a data management interface/assistant, other embodiments operate workflow generation and execution entirely in the background without user interactions. In still other embodiments, workflow generation can be performed in the background with an AI component that provides feedback on workflow steps, and executes, automatically, interactions with a respective workflow based on any one or more of: historical workflow generation, client preferences, client context (e.g., anonymize data, security priority, transform data, etc.).

In still other embodiments, the system can use the high-level goal and associated task(s) to generate a series of steps associated with each task for the high-level goal. The display can include visual elements associated with respective tasks and steps generated to complete them (e.g., 308 and 310). Tasks and steps may be grouped together. For example, a second task may be shown at 312 with associated steps at 314 and 316. In the data management context, an example high level goal can be defined as “Build Common Data Model” at 304, and an example task that makes up the high-level goal can be defined “Process Data Fields” and shown at 312. Steps within the various tasks can be defined as part of a workflow and may include for example a step to identify common data fields (314), for example, from identified source data, and a step to identify similar data fields (316) that should be merged, among other options.

In further embodiments, tasks can be defined to anonymize data, and the assistant display and chat can be configured to identify data fields having respective values that should be anonymized. Users can interact with the display of such steps to validate the AI identification of fields to be anonymized, and/or to validate the resulting anonymization, among other options.

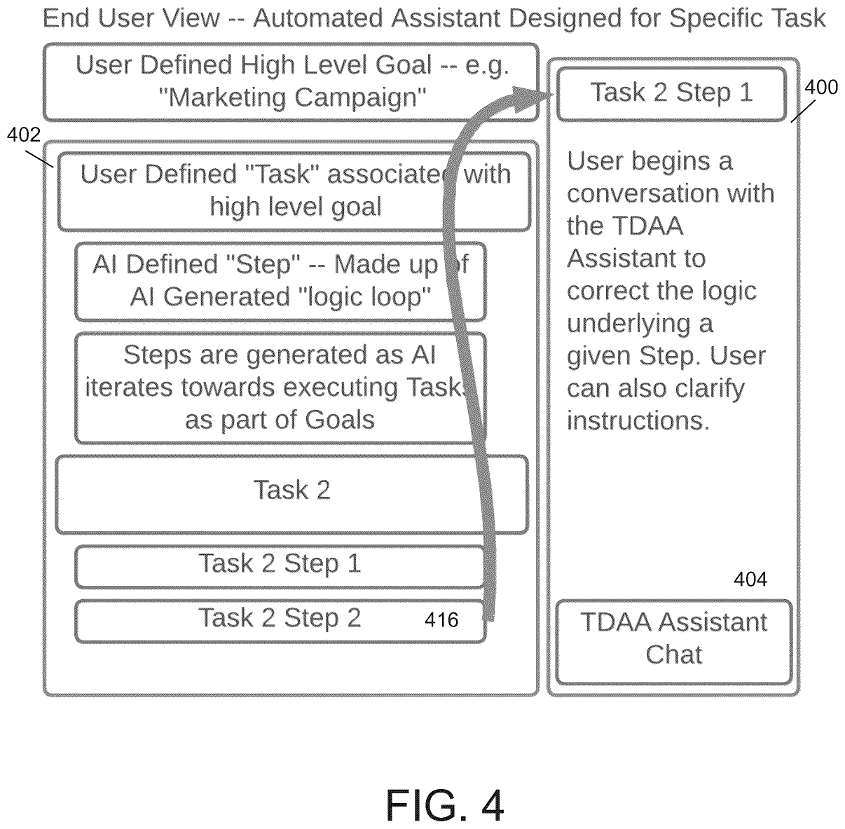

FIG. 4 shows another embodiment of the user interface 400. An AI workflow system can be configured to present user interface 400 to an end user and step through each element of the display shown on the left side of the interface at 402. For example, task two step two at 416 can be highlighted in the interface and shown on the right side of the screen so that an end user can critique or provide input on the AI defined task and/or step. Further, the user interface is configured to enable the end user to select any step or element, provide feedback, and/or trigger updates to the displayed set of steps.

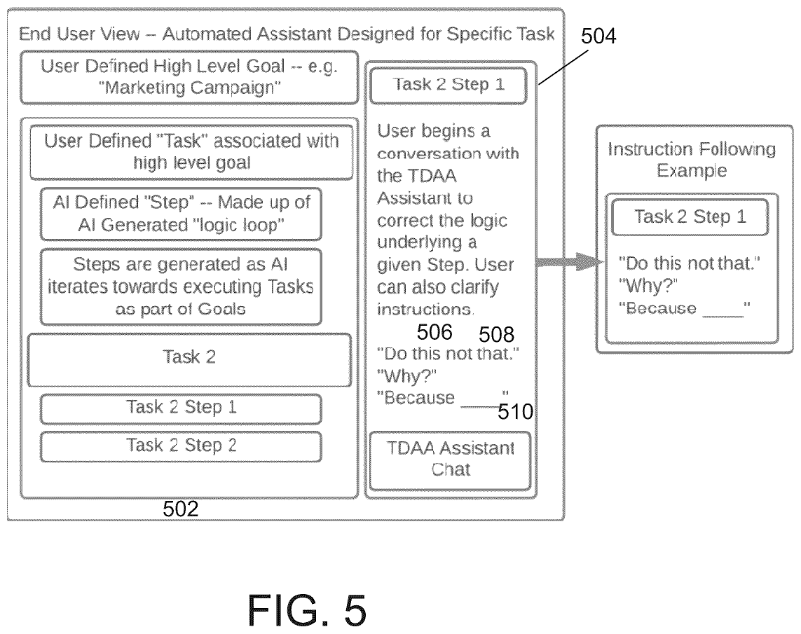

FIG. 5 shows another embodiment of a user interface 500. The user interface 500 can be configured to prompt an end user to provide information on defined steps, tasks, high-level goals, etc. According to one embodiment, an AI workflow system can be configured to present user interface 500 and guide an end user through an interaction with the visual elements shown on the left side of the display at 502. For example, the user interface 500 may include an interactive window at 504 to prompt the user for their input on respective steps and/or tasks. In one example, the system is configured to prompt the user to provide information on an action that should be taken (e.g., 506) any action that should not be taken (e.g., 508), and to provide a rationale for those constraints (e.g., 510).

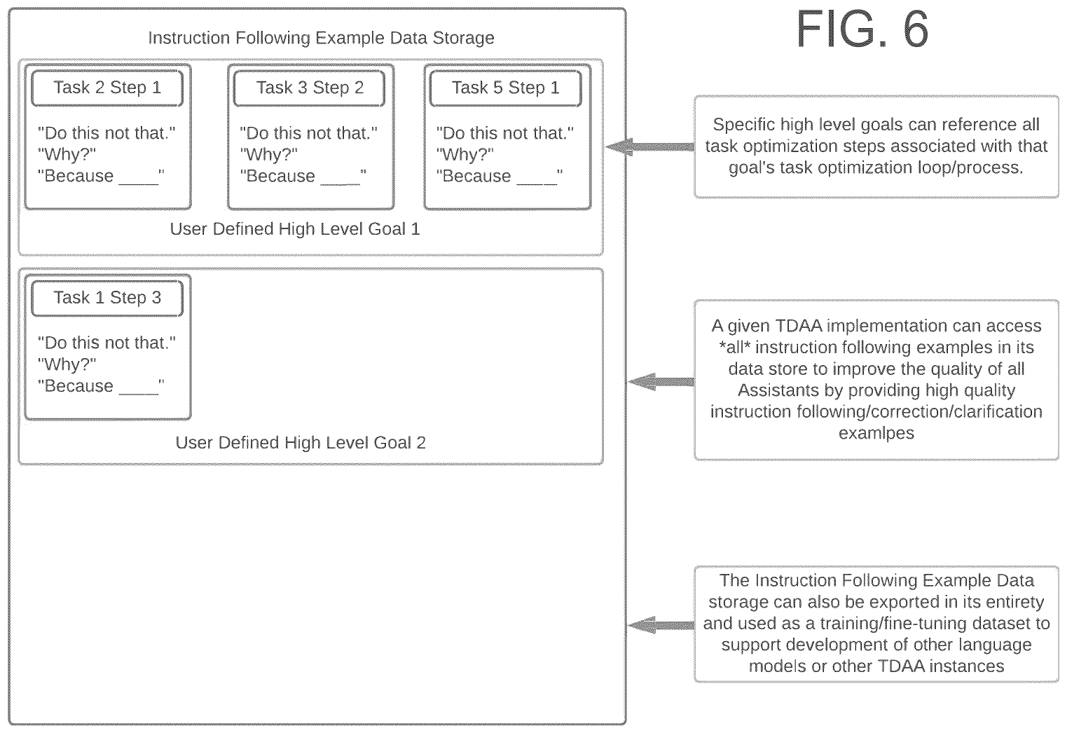

FIG. 6 illustrates a process flow associated with an interactive session. FIG. 6 highlights some respective steps of an interactive session, and the organization of specific tasks and/or steps with a respective high-level goal. The data generated during an interactive session can be stored and used to optimize the construction of tasks and/or steps for any high-level goal. As shown, each task and associated staff includes a critique or reasoning associated with the specific step. In some examples the critique and/or reasoning can be used to fine-tune or regenerate an associated step and/or task. In further embodiments, the data stored with respect to any interactive session can be used to fine tune generation of high-level goals, tasks, and/or steps. In further embodiments, the context associated with interactive sessions may also be stored and used to filter or wait data captured for use in workflow generation.

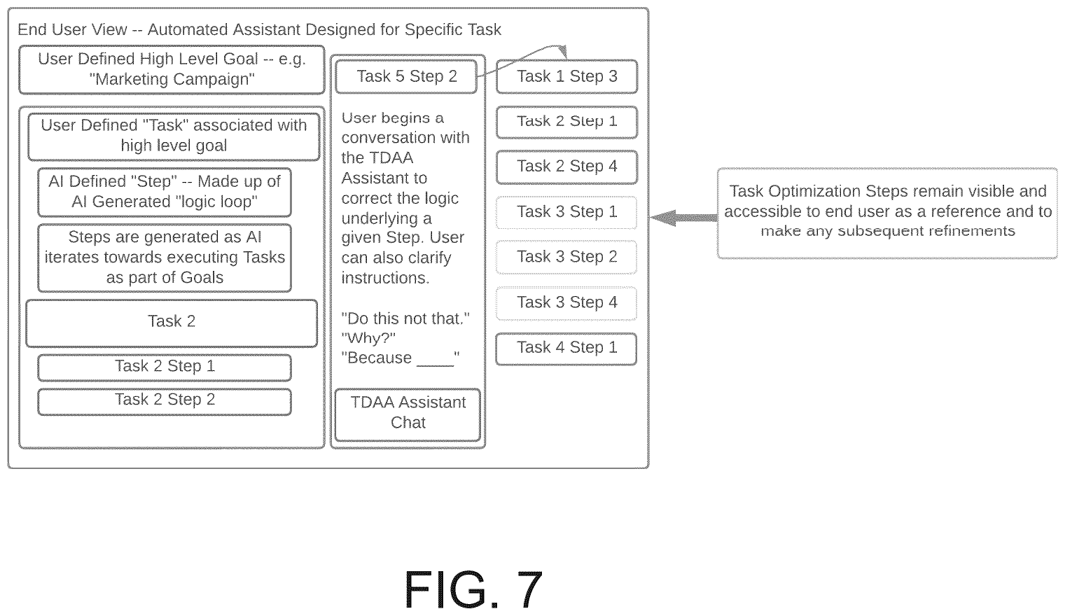

FIG. 7 is another example of a user interface presented as an end user view 700. As shown, an end user can interact with a high-level goal, tasks, and/or steps. In various embodiments, the task optimization steps remain visible in the user interface and are accessible to the end user as a reference or to make any subsequent refinements, among other options.

As discussed above, the interactive session interface described above can be presented to data administrators or client users and may also be conceptual in nature. For example, users may specify a broad concept (e.g., clean data, secure data, optimize data storage, etc.), and the system can invoke workflow generation to identify specific steps that will accomplish the broad concept. In other embodiments, the system can take on the role of feedback provider as part of a workflow generation process (e.g., requesting an LLM provide critique on respective workflow steps and/or re-generate with such feedback). Thus, while the system performs the same functions as in a user based feedback session, there is no associated display or assistant interaction with a user. In still other embodiments, the system can execute the workflow generation and use the generated workflow directly (e.g., without user or AI feedback for each step/sub-step).

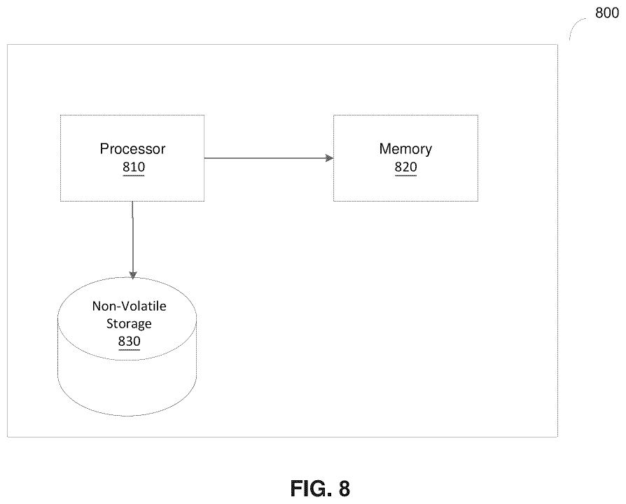

FIG. 8 is a block diagram of an example computer system that is improved by implementing the functions, operations, and/or architectures described herein. Modifications and variations of the discussed embodiments will be apparent to those of ordinary skill in the art and all such modifications and variations are included within the scope of the appended claims. Additionally, an illustrative implementation of a computer system 800 that may be used in connection with any of the embodiments of the disclosure provided herein is shown in FIG. 8. The computer system 800 may include one or more processors 810 and one or more articles of manufacture that comprise non-transitory computer-readable storage media (e.g., memory 820 and one or more non-volatile storage media 830). The processor 810 may control writing data to and reading data from the memory 820 and the non-volatile storage device 830 in any suitable manner. To perform any of the functionality described herein (e.g., image reconstruction, anomaly detection, etc.), the processor 810 may execute one or more processor-executable instructions stored in one or more non-transitory computer-readable storage media (e.g., the memory 820), which may serve as non-transitory computer-readable storage media storing processor-executable instructions for execution by the processor 810.

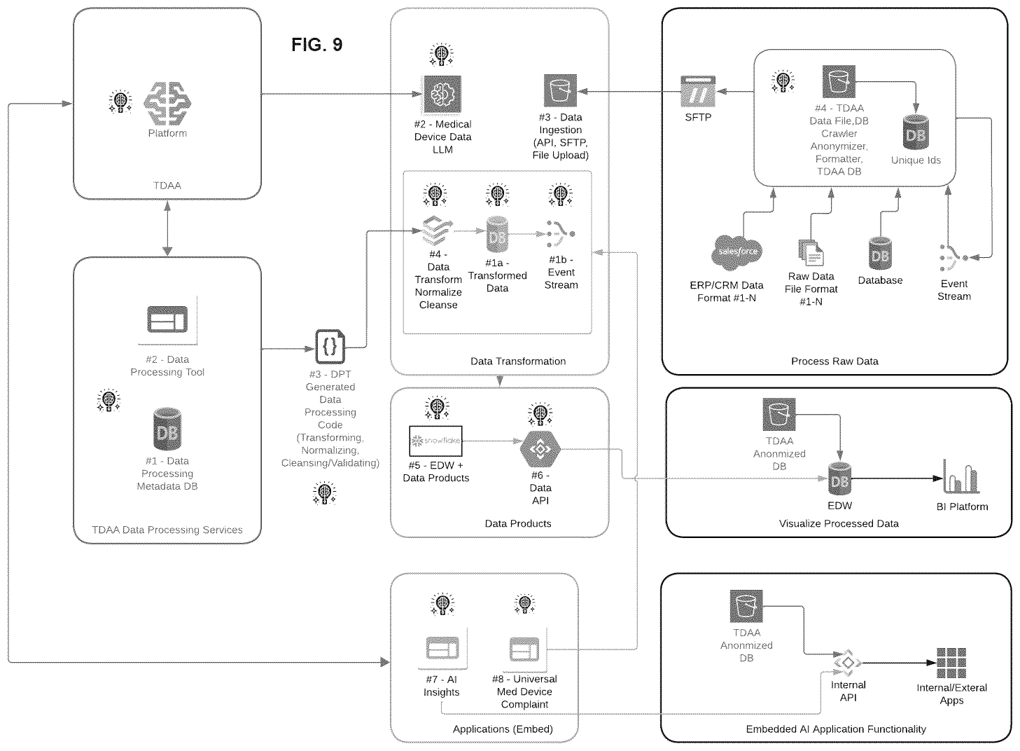

FIG. 9 is an example block diagram and functionality flow of an implementation environment. The system is implemented in a data management context and provides a function suite to assist a data holder (e.g., client or user) in building a comprehensive data model for their data, automatically perform computationally expensive normalization tasks, data deduplication, data backup, data cleansing, data validation, data anonymization, among other options. In some embodiments, the platform (e.g., TDAA) is configured to build and deliver code for the described functions, and clients can execute the code deliverable, securing operation in whatever manner the client wants to implement. According to one embodiment, the system can be separately configured to anonymize any data specified by a client and can do so on the client's systems.

In various embodiments, even the most sensitive data source (e.g., medical data, medical device data, etc.) can be handled via the data management platform (e.g., TDAA) and distributed functionality that enables the client to leverage the data management functions in secure data environments controlled by the client. Additionally, once the data has been reduced to an anonymized (and may include a common formatting), the ability to perform analytics in the anonymized data environment is significantly improved. AI generated insights can be used to meaningfully use the data sources, and commonality in the formation and even anonymization of the data makes the underlying data better for analytics. Further, workflow based AI processing for data analytics can be leveraged to improve any requested result and/or analysis driven by AI.

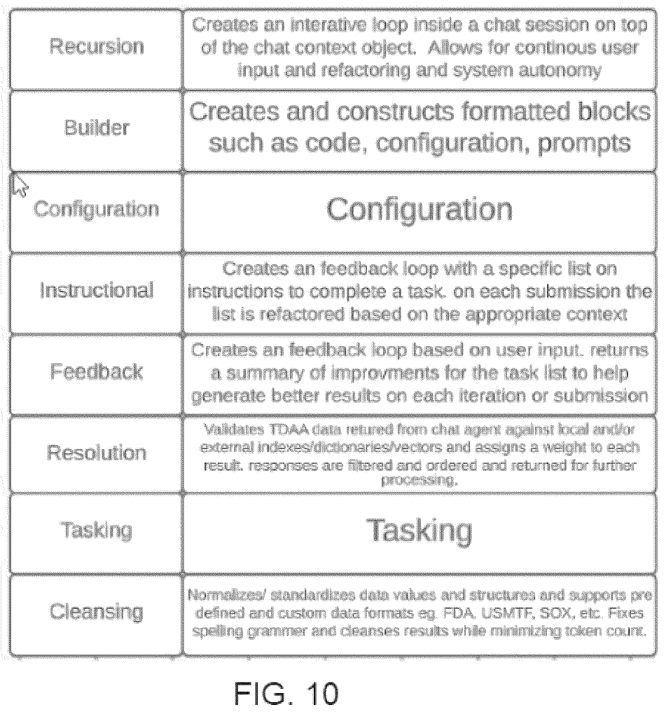

FIG. 10 shows example logic blocks that can be implemented as part of the system. For example, in improving user interaction with AI models, the system can invoke operations to create an interactive loop inside a chat session that allows for continuous user input and re-factoring the regeneration of steps for a workflow. In some embodiments, this can be designated as a recursion block. The recursion block can be configured to accept feedback and regenerate workflow steps until validation is performed or no more feedback is received. In further embodiments, a builder logic block can be executed to create and construct formatted blocks via an AI, where the formatted blocks can be code, configurations, and/or prompts, among other examples.

According to one embodiment, a configuration logic block can be executed to determine configurations for a given user context or configurations for a specific task being requested. In some examples, this could include capturing configuration information from a client environment, client data source, client application, or any client identification of a target to use with her request.

In some embodiments, an instructional logic block can be executed to provide a feedback loop with a more specific list of instructions to complete a task. During execution of the instructional lock, each submission to a member of the list is used to re-factor the respective instruction or used to re-factor the entire list based on a specific context. In other embodiments, a feedback logic block can be configured to create a feedback loop based on user input, which may include user validation of an operation instruction or task. The feedback may also include specification of actions to be taken with respect to a task as well as actions not to be taken or ignore instructions that can be used to improve workflow execution.

According to one embodiment, a resolution logic block can be executed to validate data returned from a chat agent against local and/or external indices, dictionaries, and/or vectors. According to one example, execution of the resolution logic block can include assignment of weights to the validation results. In further examples, the weighted results can be filtered and ordered and returned for further processing.

In various embodiments, the system can execute a tasking logic block that is configured to refine and/or tailor specific tasks within a workflow and/or instructions within a specific task. In some examples, the system and/or AI model can be used to identify similar tasks in similar contexts and tailor workflow construction to incorporate the same. In other embodiments, the system can execute a cleansing logic block configured to normalize and/or standardize data values and data structures. In further examples, the cleansing block may be configured to normalize and/or standardize data values and supports that are predefined and/or to include custom data formats (e.g., FDA, USMTF, SOX, etc.). in some examples, the cleansing block can be configured to fix spelling and/or grammar errors and cleanse results while minimizing token count.

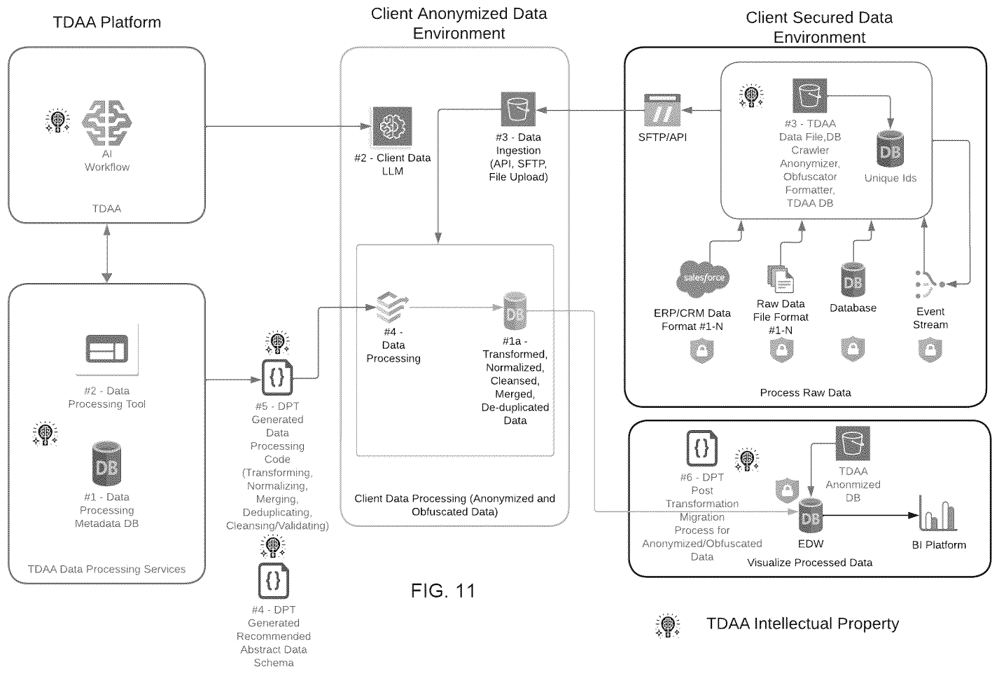

FIG. 11 is a block diagram of an example implementation for a workflow and data management system. The block diagram highlights some of the functions and features discussed above. For example, the system can include a data management platform that allows client system to interact with data management functions and operations both in remote and local settings. For example, a client hosting medical device data may need strict data control and security. One example criterion in such settings can include requirements that no un-anonymized or no un-obfuscated data can leave the client's systems. This data processing code can be produced for the client to execute against their data in whatever security context they require.

In further embodiments, the system can also enable a user (e.g., a client) to undo transformation, anonymizations, and/or obfuscation, etc., in an on-demand manner. The system provides the underlying code generation that enables simple selections in a UI or identification of a destination and format options to be executed in whatever security context the client has established. According to some embodiments, the reversal or re-integration can be temporally constrained, or secured in such a manner to ensure only users with the highest security settings/permission have access. In some embodiments, the system is configured to generate code that can be copied to physical media, and used to re-integrate data repositories on air gapped system (e.g., completely unconnected to networks and signals). Various security settings and environments can be established and be the destination for operations enabled by the system.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationships between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples (e.g., the processes described herein) have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

In other embodiments, various ones of the functions and/or portions of the flows discussed herein can be executed in different order. In still other embodiments, various ones of the functions and/or portions of the flow can be omitted, or consolidated. In yet other embodiments, various ones of the functions and/or portions of the flow can be combined, and used in various combinations of the disclosed flows, portions of flows, and/or individual functions. In various examples, various ones of the screens, functions and/or algorithms can be combined, and can be used in various combinations of the disclosed functions.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A system comprising at least one processor operatively connected to a memory, the at least one processor when executing configured to:
generate and display a guided session for data management interaction;
accept a user input specifying at least some of a request to be processed by a first AI model;
generate a candidate workflow for executing a data management operation using the first AI model, the candidate workflow constrained to comprise a plurality of steps;
process feedback on respective ones of the plurality of steps; and
optimize generation of a final output for the data management operation based, at least in part, on execution of the candidate workflow by the first AI model, and any feedback on the respective ones of the plurality of steps.

2. The system of claim 1, wherein the at least one processor is configured to trigger the first AI model to produce the candidate workflow to include at least one or more steps configured to produce anonymized data from at least one source data target.

3. The system of claim 2, wherein the at least one processor is configured to generate a unique identifier for linking anonymized information to an original record.

4. The system of claim 2, wherein the at least one processor is configured to:
optimize the one or more steps configured to produce anonymized data from the at least one source data target based on providing the feedback to the first AI model.

5. The system of claim 4, wherein the optimization includes functions to regenerate the one or more steps configured to produce anonymized or obscured data from the at least one source data target.

6. The system of claim 1, wherein the at least one processor is configured to process groupings of the plurality of steps based on associated tasks.

7. The system of claim 1, wherein the at least one processor is configured to process groupings of the plurality of steps that include sub-steps associated with at least a respective one of the plurality of steps.

8. The system of claim 1, wherein the at least one processor is configured to:
enable selection of respective ones of the plurality of steps, and
display a request for feedback on a selected one of the plurality of steps.

9. The system of claim 8, wherein the at least one processor is configured to regenerate the selected one of the plurality of steps based at least in part on the feedback using the first AI model or regenerate the candidate workflow based at least in part on the feedback using the first AI model.

10. The system of claim 1, further comprising a second AI model configured to generate executable code from any one or more of the plurality of steps.

11. The system of claim 10, wherein the second AI model is a large language model (“LLM”) trained to produce executable code in response to a text or natural language input.

12. The system of claim 11, wherein the first and second AI model are a same AI model.

13. A computer implemented method comprising:
generating and displaying, by at least one processor, a guided session for data management interaction;
accepting, by the at least one processor, a user input specifying at least some of a request to be processed by a first AI model;
generating, by the at least one processor, a candidate workflow for executing a data management operation using the first AI model, the candidate workflow constrained to comprise a plurality of steps;
processing, at least one processor, feedback on respective ones of the plurality of steps; and
optimize generation of a final output for the data management operation based, at least in part, on execution of the candidate workflow by the first AI model, and any feedback on the respective ones of the plurality of steps.

14. The method of claim 13, wherein the method comprises triggering the first AI model to produce the candidate workflow and include at least one or more steps configured to produce anonymized data from at least one source data target.

15. The method of claim 14, wherein the method further comprises generating a unique identifier for linking anonymized information to an original record.

16. The method of claim 14, wherein the method further comprises optimizing the one or more steps configured to produce anonymized data from the at least one source data target based on providing the feedback to the first AI model.

17. The method of claim 16, wherein the optimization includes functions to regenerate the one or more steps configured to produce anonymized or obscured data from the at least one source data target.

18. The method of claim 14, wherein the method further comprises processing groupings of the plurality of steps based on associated tasks.

19. The method of claim 14, wherein the method further comprises processing groupings of the plurality of steps that include sub-steps associated with at least a respective one of the plurality of steps.

20. The method of claim 14, wherein the method further comprises:
enabling selection of respective ones of the plurality of steps, and
displaying a request for feedback on a selected one of the plurality of steps.

21. The method of claim 22, wherein the method further comprises regenerating the selected one of the plurality of steps based at least in part on the feedback using the first AI model or regenerating the candidate workflow based at least in part on the feedback using the first AI model.

22. The method of claim 1, further comprising a second AI model configured to generate executable code from any one or more of the plurality of steps.

23. The method of claim 22, wherein the second AI model is a large language model (“LLM”) trained to produce executable code in response to a text or natural language input.

24. The method of claim 23, wherein the first and second AI model are a same AI model.
